(19) United States
(12) Patent Application Publication
(10) Pub. No.: US 2013/0007526 A1
(43) Pub. Date: Jan. 3, 2013

(54) DEFECT CLOSURE

(75) Inventors: Philip R. Riedel, Cary, NC (US); John Anthony Griffith, Austin, TX (US); Daniel Patrick Rhames, Austin, TX (US); David Lloyd Schmidt, Cary, NC (US)

(73) Assignee: International Business Machines Corporation, Armonk, NY (US)

(21) Appl. No.: 13/173,834

(22) Filed: Jun. 30, 2011

(51) Int. Cl. G06F 11/07

(52) U.S. Cl. 714/37; 714/E11.029

(57) ABSTRACT

A method, computer program product, and system for defect closure is described. A method may allowing, via one or more computing devices, a user to define one or more parameters associated with a defect. The method may further comprise modifying, via the one or more computing devices, a care-value associated with the defect, as a function of time, based upon, at least in part, the one or more parameters defined by the user. The method may additionally comprise, in response to determining that the defect is unresolved after a configurable time period, closing, via the one or more computing devices, the defect.

### BACKGROUND OF THE INVENTION

Product development projects may include multiple phases of testing and resolving defects in the product. These defects may be managed by a team member and/or manager. The team member and/or manager may not have enough resources available to resolve each defect as multiple defects are found during a testing phase. As such, the development team may resolve the most important defects first while delaying the handling of less important defects. Less important defects may be pushed to the end of the line, or may never be resolved at all.

### BRIEF SUMMARY OF THE INVENTION

In a first embodiment, a method may include allowing, via one or more computing devices, a user to define one or more parameters associated with a defect. The method may further include modifying, via the one or more computing devices, a care-value associated with the defect, as a function of time, based upon, at least in part, the one or more parameters defined by the user. The method may also include, in response to determining that the defect is unresolved after a configurable time period, closing, via the one or more computing devices, the defect.

One or more of the following features may be included. The method may include prioritizing the defect based upon, at least in part, the modified care-value. The method may additionally include notifying one or more team members of the defect based upon, at least in part, the modified care-value. The one or more parameters may include an initial care-value for the care-value associated with the defect. Further, the one or more parameters may include a maximum care-value increase for the care-value associated with the defect.

In an implementation, the one or more parameters may include an attack time period for the defect corresponding to an amount of time to increase the care-value associated with the defect to a maximum care-value. Further, the one or more parameters may include a sustain time period for the defect corresponding to an amount of time to hold the care-value associated with the defect at a maximum care-value. Also, the one or more parameters may include a release time period for the defect corresponding to an amount of time to decrease the care-value associated with the defect until the defect is closed. Additionally, the one or more parameters may include a honeymoon time period for the defect corresponding to an amount of time to hold the care-value associated with the defect at an initial care-value.

In a second embodiment, a computer program product may reside on a computer readable storage medium and may have a plurality of instructions stored on it. When executed by a processor, the instructions may cause the processor to perform operations including allowing a user to define one or more parameters associated with a defect. The operations may further include modifying a care-value associated with the defect, as a function of time, based upon, at least in part, the one or more parameters defined by the user. The operations may also include, in response to determining that the defect is unresolved after a configurable time period, closing the defect.

One or more of the following features may be included. The operations may include prioritizing the defect based upon, at least in part, the modified care-value. The operations may additionally include notifying one or more team members of the defect based upon, at least in part, the modified care-value. The one or more parameters may include an initial care-value for the care-value associated with the defect. Further, the one or more parameters may include a maximum care-value increase for the care-value associated with the defect.

In an implementation, the one or more parameters may include an attack time period for the defect corresponding to an amount of time to increase the care-value associated with the defect to a maximum care-value. Further, the one or more parameters may include a sustain time period for the defect corresponding to an amount of time to hold the care-value associated with the defect at a maximum care-value. Also, the one or more parameters may include a release time period for the defect corresponding to an amount of time to decrease the care-value associated with the defect until the defect is closed. Additionally, the one or more parameters may include a honeymoon time period for the defect corresponding to an amount of time to hold the care-value associated with the defect at an initial care-value.

In a third embodiment, a computing system is provided. The computing system may include at least one processor and at least one memory architecture coupled with the at least one processor. The computing system may also include a first software module executable by the at least one processor and the at least one memory architecture, wherein the first software module may be configured to allow a user to define one or more parameters associated with a defect. Further, the computing system may include a second software module which may be configured to modify a care-value associated with the defect, as a function of time, based upon, at least in part, the one or more parameters defined by the user. Additionally, the computing system may include a third software module which may be configured to, in response to determining that the defect is unresolved after a configurable time period, close the defect. In an implementation, the computing system may include a fourth software module which may be configured to prioritize the defect based upon, at least in part, the modified care-value.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a defect closure process coupled to a distributed computing network;

FIG. 2 is a flowchart of the defect closure process of FIG. 1;

FIG. 3 is a graphical user interface which may be associated with the defect closure process of FIG. 1;

FIG. 4 is a graph which may be associated with the defect closure process of FIG. 1;

FIG. 5 is an exemplary table and graph which may be associated with the defect closure process of FIG. 1; and

FIGS. 6-9 are also exemplary tables and graphs which may be associated with the defect closure process of FIG. 1.

### DETAILED DESCRIPTION OF THE INVENTION

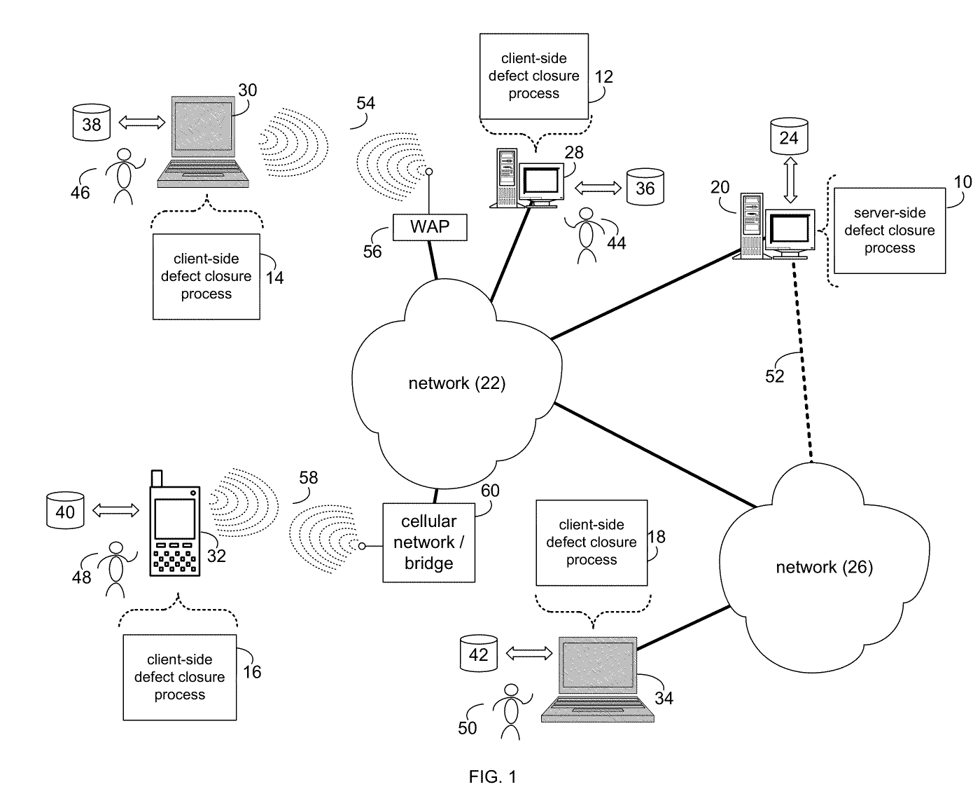

Referring to FIGS. 1 & 2, there is shown a defect closure process 10. As will be discussed below, defect closure process 10 may allow 100 a user to define one or more parameters associated with a defect. Defect closure process 10 may also modify 102 a care-value associated with the defect, as a function of time, based upon, at least in part, the one or more parameters defined by the user. Defect closure process 10 may further, in response to determining that the defect is unresolved after a configurable time period, close 104 the defect.

The defect closure (DC) process may be a server-side process (e.g., server-side DC process 10), a client-side process (e.g., client-side DC process 12, client-side DC process 14, client-side DC process 16, or client-side DC process 18), or a hybrid server-side/client-side process (e.g., the combination of server-side DC process 10 and one or more of client-side DC processes 12, 14, 16, 18).

Server-side DC process 10 may reside on and may be executed by server computer 20, which may be connected to network 22 (e.g., the Internet or a local area network). Examples of server computer 20 may include, but are not limited to: a personal computer, a server computer, a series of server computers, a mini computer, and/or a mainframe computer. Server computer 20 may be a web server (or a series of servers) running a network operating system, examples of which may include but are not limited to: Microsoft Windows Server; Novell Netware; or Red Hat Linux, for example.

The instruction sets and subroutines of server-side DC process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); and a read-only memory (ROM).

Server computer 20 may execute a web server application, examples of which may include but are not limited to: Microsoft IIS, Novell Web Server, or Apache Web Server, that allows for access to server computer 20 (via network 22) using one or more protocols, examples of which may include but are not limited to HTTP (i.e., HyperText Transfer Protocol), SIP (i.e., session initiation protocol), and the Lotus® Sametime® VP protocol. Network 22 may be connected to one or more secondary networks (e.g., network 26), examples of which may include but are not limited to: a local area network; a wide area network; or an intranet, for example.

Client-side DC processes 12, 14, 16, 18 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 22 and/or network 26 and may each execute an operating system, examples of which may include but are not limited to Microsoft Windows, Microsoft Windows CE, Red Hat Linux, or a custom operating system.

The instruction sets and subroutines of client-side DC processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

Client-side DC processes 12, 14, 16, 18 and/or server-side DC process 10 may be processes that run within (i.e., are part of) a lifecycle management and/or defect management application (e.g., IBM® Rational® Quality Manager). Alternatively, client-side DC processes 12, 14, 16, 18 and/or server-side DC process 10 may be stand-alone applications that work in conjunction with the lifecycle management and/or defect management application. One or more of client-side DC processes 12, 14, 16, 18 and server-side DC process 10 may interface with each other (via network 22 and/or network 26).

Users 44, 46, 48, 50 may access server-side DC process 10 directly through the device on which the client-side DC process (e.g., client-side DC processes 12, 14, 16, 18) is executed, namely client electronic devices 28, 30, 32, 34, for example. Users 44, 46, 48, 50 may access server-side DC process 10 directly through network 22 and/or through secondary network 26. Further, server computer 20 (i.e., the computer that executes server-side DC process 10) may be connected to network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, 802.11n, Wi-Fi, and/or Bluetooth device that is capable of establishing wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### The Defect Closure (DC) Process

For the following discussion, server-side DC process 10 will be described for illustrative purposes. It should be noted that client-side DC process 12 may interact with server-side DC process 10 and may be executed within one or more applications that allow for communication with client-side DC process 12. However, this is not intended to be a limitation of this disclosure, as other configurations are possible (e.g., stand-alone, client-side DC processes and/or stand-alone server-side DC processes.) For example, some implementations may include one or more of client-side DC processes 12, 14, 16, 18 in place of or in addition to server-side DC process 10.

As discussed above, product development projects may include multiple phases of testing and resolving defects in the product. Projects may include, for example, development of software, hardware, machines, buildings and/or any product that includes components. Defects may be managed by a team member and/or manager. The team member and/or manager may not have enough resources available to resolve each defect if multiple defects are found during a testing phase. As such the manager may have to prioritize each defect to determine which defects will be handled first. For example, defects that affect many customers or disrupt many parts of the product may be assigned (e.g., by the manager) the highest priority and/or severity levels. Defects that are internal and not yet known to affect any customers or disrupt any parts may be assigned (e.g., by the manager) the lowest priority and/or severity levels. As such, the development team may resolve the most important defects (i.e., those with the highest priority and/or severity levels) first while delaying the handling of less important defects (i.e., those with the lowest priority and/or severity levels). Less important defects may be pushed to the end of the line, or may never be resolved at all.

In an example, an Agile software development process may include one or more cycles for evaluating defects. When a defect is first raised, the manager may evaluate the defect and the defect may be prioritized for handling. A defect may be, for example, a bug in the software. One or more developers may work on defects at the top of a priority list for a cycle. Defects not handled by the end of the cycle may need to be re-evaluated, closed, re-opened and/or otherwise revisited during the next cycle, if they have not been resolved in the last cycle. Defects that have lived through many cycles may lie just outside of the team's capacity fix them. These defects may not have a very high level of severity or may not affect a customer, so their priorities may go unchanged for many cycles. It may be determined (by, e.g., the manager) that a defect that has lived through many cycles is not important to resolve and the defect may be closed. Managers responsible for defects may not have time to revisit these defects over and over again. As such, an automated process for handling defects and bringing them to closure may allow managers to save time.

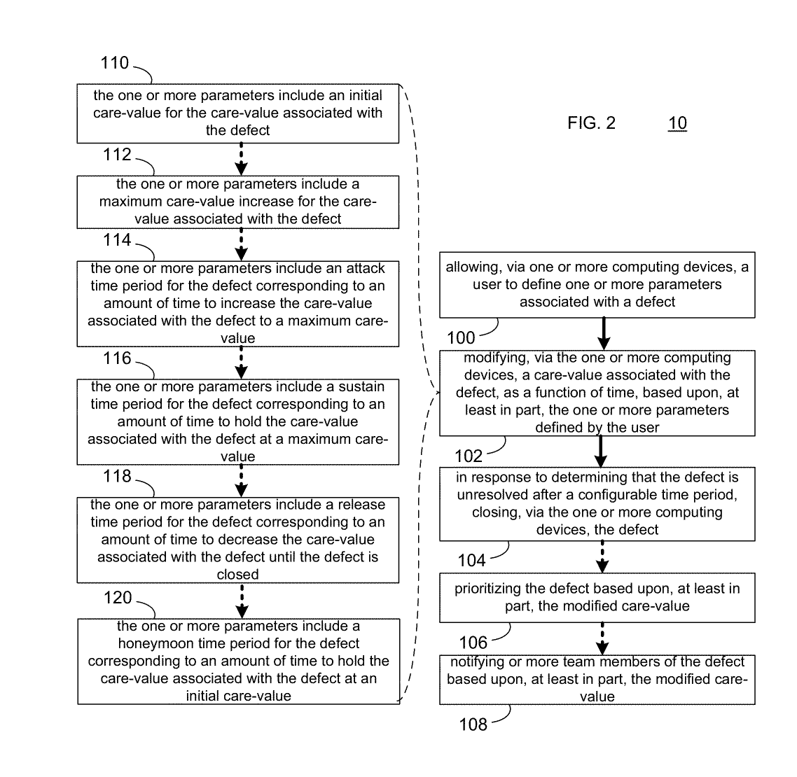

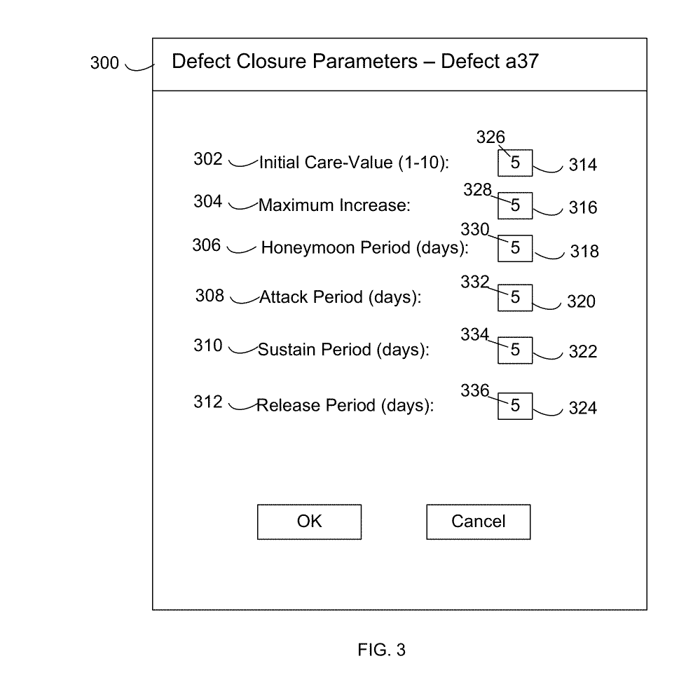

Referring now to FIGS. 1-3, DC process 10 may allow 100 a user (e.g., one or more of users 44, 46, 48, 50) to define one or more parameters (e.g., one or more of parameters 302, 304, 306, 308, 310, 312) associated with a defect (e.g., defect a37). DC process 10 may render a graphical user interface (GUI) (e.g., GUI 300), which may be available from the lifecycle management and/or defect management application (e.g., IBM® Rational® Quality Manager). User 44, for example, may be the project manager and may define one or more of parameters 302, 304, 306, 308, 310, 312 by entering a value in one or more of corresponding fields 314-324.

A care-value may be a value assigned to a defect based upon how severe the defect is and/or a priority of the defect. As discussed above, a manager (e.g., user 44) may have to prioritize each defect to determine which defects will be handled first. The care-value for each defect may quantify a relative importance of each defect. For example, the one or more parameters (e.g., one or more of parameters 302, 304, 306, 308, 310, 312) may include (110) an initial care-value (e.g., value 326) for the care-value associated with the defect (e.g., defect a37). When user 44 first evaluates the defect, he/she may assign the defect an initial care-value. For example, user 44 may enter the initial care value in field 314 of GUI 300. Ordinarily, the care-value may be increased and/or decreased as further information is collected by the team. For example, as more customers report an issue with the defect, one or more team members may increase the care-value.

DC process 10 may modify 102 a care-value (e.g., initial care-value 326) associated with the defect (e.g., defect a37), as a function of time, based upon, at least in part, the one or more parameters (e.g., one or more of parameters 302, 304, 306, 308, 310, 312) defined by the user (e.g., user 44). As discussed above, less important defects may be carried over through multiple cycles and may take much longer to resolve, if they are ever resolved before closure. The one or more parameters (e.g., one or more of parameters 302, 304, 306, 308, 310, 312) of DC process 10 may allow the manager (e.g., user 44) to raise the priority of a defect (e.g., defect a37) by altering a care-value associated with the defect. For example, if defect a37 has been through one or more cycles and aged without being resolved, user 44 may temporarily increase the care-value of defect a37, in order to bring it to a developer's attention. Even though defect a37 may not have been resolved because it was given a low initial care-value, DC process 10 may allow user 44 to force defect a37 to a developer's attention to resolve the defect.

The one or more parameters (e.g., one or more of parameters 302, 304, 306, 308, 310, 312) of DC process 10 may also include (112) a maximum care-value increase (e.g., value 328) for the care-value associated with the defect (e.g., defect a37). Maximum care-value increase 328 may correspond to the highest increase that the care-value associated with defect a37 can have. Even though user 44 may wish to bring defect a37 to a developer's attention, user 44 may not wish for defect a37 to be so important that it takes priority over too many other important defects. In this way, DC process 10 may allow user 44 to increase the priority of defect a37 (with, e.g., maximum care-value increase 328) without compromising the priority of the most important defects.

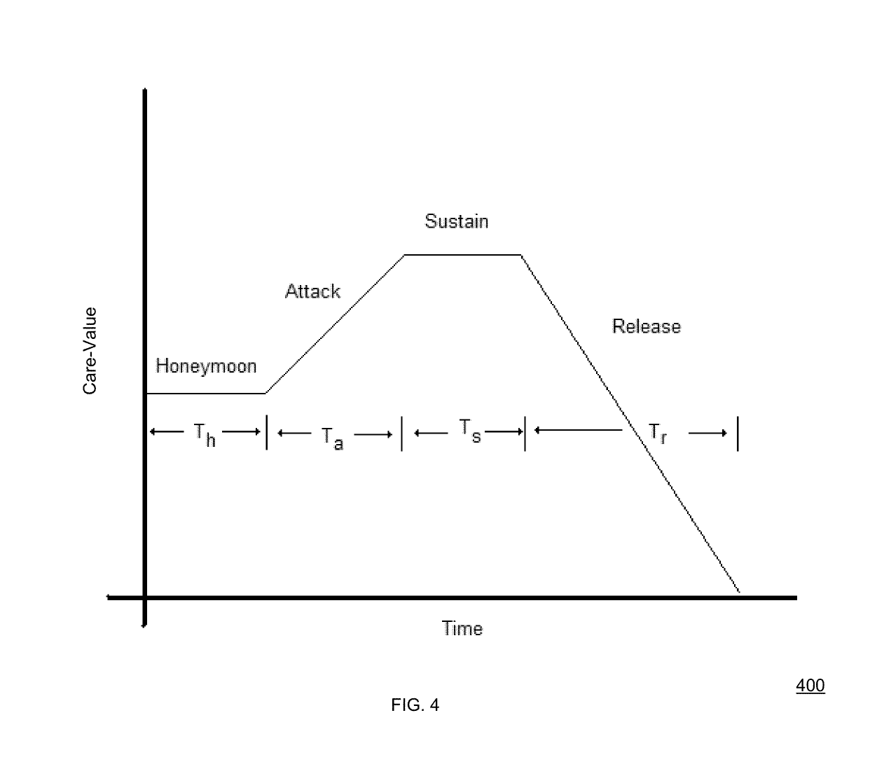

Further, the one or more parameters may include (120) a honeymoon time period Tₕ, (e.g., honeymoon period 306) for the defect (e.g., defect a37) corresponding to an amount of time (e.g., period value 330) to hold the care-value (e.g., initial care-value 326) associated with the defect (e.g., defect a37) at an initial care-value (e.g., initial care-value 326). Referring now also to FIG. 4, graph 400 may show honeymoon time period Tₕ as a period for which DC process 10 may keep the care-value constant, before ramping the care-value up. The honeymoon period Tₕ may correspond to an amount of time that the manager wishes wait before increasing the care-value of the defect and, in turn, increasing the likelihood that the defect will be resolved.

The one or more parameters may also include (114) an attack time period, Tₐ (e.g., attack period 308) for the defect (e.g., defect a37) corresponding to an amount of time (e.g., period value 332) to increase the care-value (e.g., initial care-value 326) associated with the defect (e.g., defect a37) by the maximum care-value increase (e.g., value 328). In other words, after honeymoon time period Tₕ has passed for defect a37, DC process 10 may gradually increase the care-value (e.g., initial care-value 326) associated with the defect (e.g., defect a37) during attack time period, Tₐ. Based upon, at least in part, the maximum care-value increase (e.g., value 328), DC process 10 may gradually increase initial care-value 326 for attack time period, Tₐ. While DC process 10 is shown in FIG. 4 to increase the care-value linearly, as a function of time (e.g., for attack time period, Tₐ), this is shown for exemplary purposes only, and other variations are possible.

Additionally, the one or more parameters may include (116) a sustain time period Tₛ (e.g., sustain period 310) for the defect (e.g., defect a37) corresponding to an amount of time (e.g., period value 334) to hold the care-value associated with the defect (e.g., defect a37) at a maximum care-value. The maximum care value may correspond to the initial care-value (e.g., initial care-value 326) plus the maximum care-value increase (e.g., value 328). As shown in FIG. 4 and graph 400, DC process 10 may hold the care-value associated with the defect (e.g., defect a37) at the maximum care-value for sustain time period Tₛ. Further, the one or more parameters may include (118) a release time period Tᵣ (e.g., release period 312) for the defect (e.g., defect a37) corresponding to an amount of time (e.g., period value 336) to decrease the care-value associated with the defect (e.g., defect a37) until the defect (e.g., defect a37) is closed. As shown in FIG. 4, DC process 10 may decrease the care-value associated with the defect (e.g., defect a37) from the maximum care-value to zero for release time period Tᵣ.

DC process 10 may determine that the defect (e.g., defect a37) is unresolved, after a configurable time period. The configurable time period may correspond to a development cycle, as discussed above. The configurable time period may end when sustain time period Tₛ ends, or, in other words, when the care-value for defect a37 reached zero. In response to determining that the defect (e.g., defect a37) is unresolved after a configurable time period, DC process 10 may close 104 the defect (e.g., defect a37). At his point, defect a37 may have made it through one or more cycles and still not been resolved. In this way, DC process 10 may automate the handling of defects in order to close them when it becomes clear that they are unlikely to be fixed. This may save user 44 time because user 44 may no longer have to evaluate defect a37 after each cycle or other evaluation period.

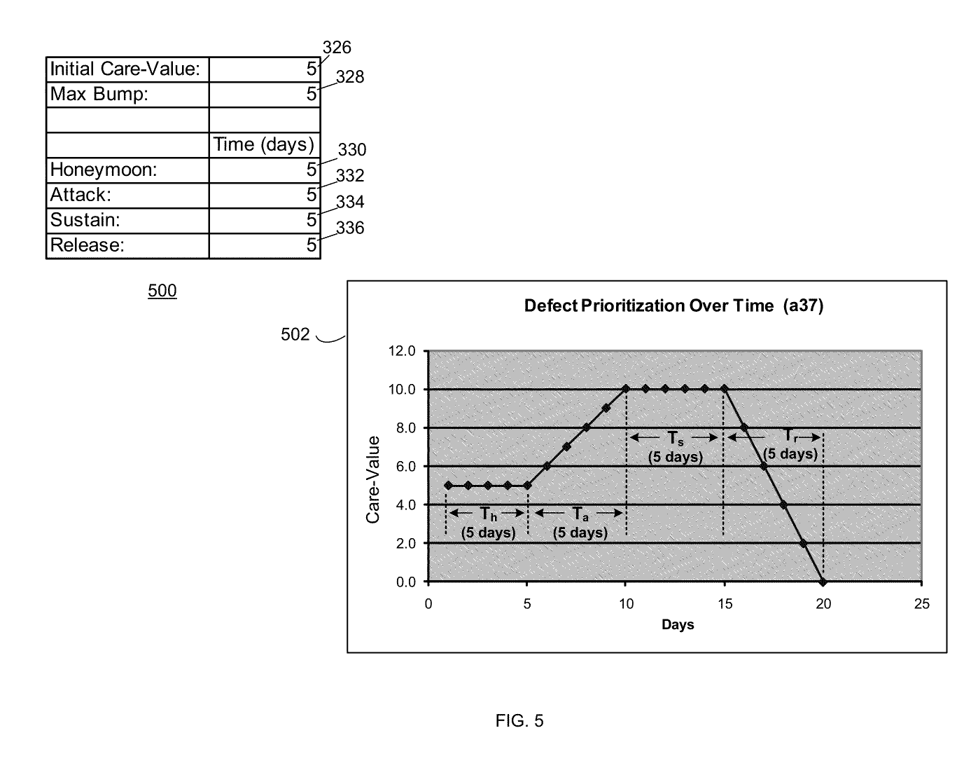

Referring now to FIG. 5, table 500 may include one or more values entered by user 44 in GUI 300 for defect a37. Further, graph 502 may show the care-value as a function of time (i.e., days) for defect a37. This may also be referred to as defect prioritization over time. As shown in FIG. 5, during the honeymoon period Tₕ (i.e., the first 5 days of the cycle), the care-value may stay at the initial care-value, or 5, for 5 days. During this time developer's may not have noticed defect a37 because of its relatively low care-value. After the honeymoon period, and during the attack period Tₐ, the care-value may begin to gradually increase. This is because DC process 10 may have modified 102 initial care-value 326 associated with the defect a37, as a function of time, based upon, at least in part, maximum increase value 328 and attack period value 332 as defined by user 44. During this time a developer may be more likely to notice defect a37 because its care-value may be increasing.

For example, DC process 10 may prioritize 106 the defect (e.g., defect a37) based upon, at least in part, the modified care-value. DC process 10 may provide a defect list to one or more developers including known defects in order of priority. During the attack period Tₐ, defect a37 may rise on this list and become more apparent to one or more developers. Further, DC process 10 may notify 108 one or more team members (e.g., developers) of the defect (e.g., defect a37) based upon, at least in part, the modified care-value. For example, developers may be notified of all defects with care-values of “8” or greater. As such, when defect a37's care-value reaches “8” during attack period Tₐ, one or more developers may be notified of it.

Continuing with the above example, during the sustain period Tₛ, and once the care-value reaches its maximum value, the care-value may stay at its maximum value for sustain period Tₛ (e.g., period value 334, or for as long a time as defined by user 44). Sustain period Tₛ may be the most likely time that defect a37 may be resolved as this corresponds to the highest priority it will get. Also during this time, as other defects are resolved, defect a37 may move up on the priority list. However, defect a37 may reach the end of sustain period Tₛ without being resolved and this may trigger release period Tᵣ. During release period Tᵣ, the care-value associated with defect a37 may gradually decrease until defect a37 is either resolved, or until the care-value reaches zero. During release period Tᵣ, defect a37 may still be noticed and resolved as other defects on the priority list may be resolved and may make room for defect a37 to move up. If defect a37 is not resolved by the end of release period Tᵣ, defect a37 may be closed. In this way, DC process 10 may automate the closure of a defect by modifying the care-value according to user defined parameters in order to increase the defect's priority. If the defect is still not resolved, it may be apparent the defect is not likely to be resolved and it may be closed.

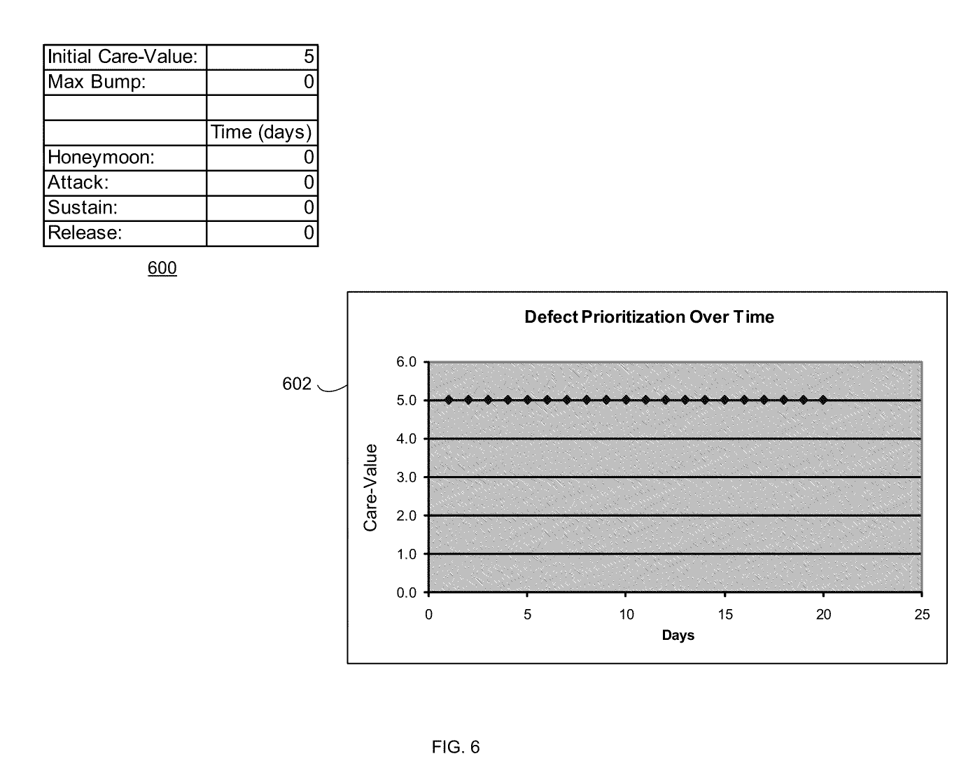

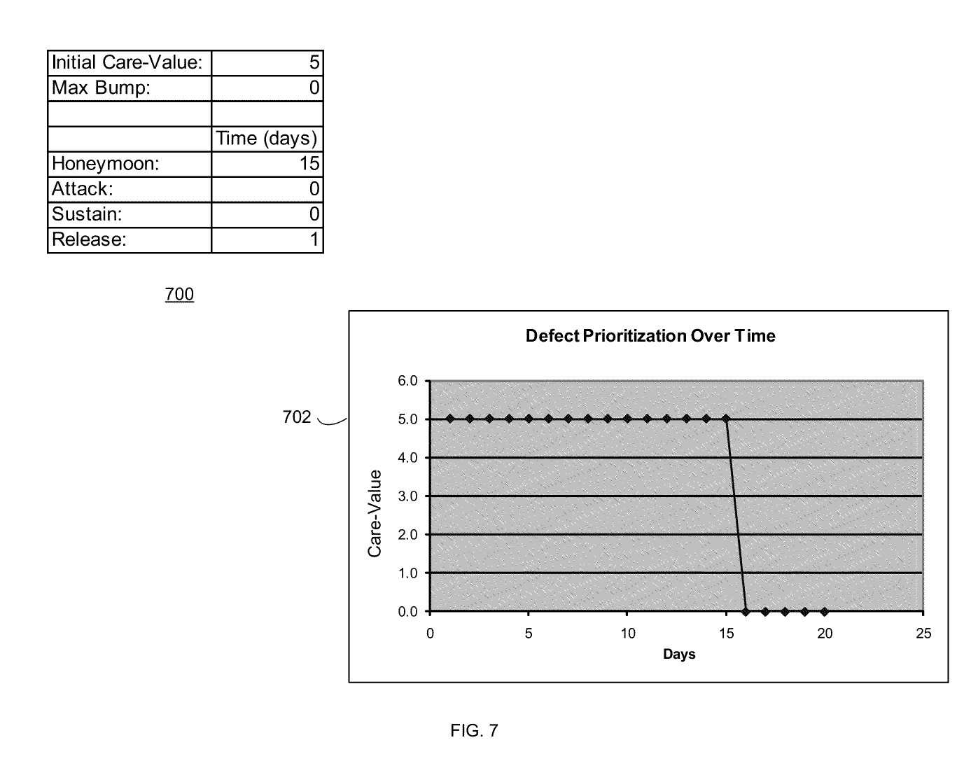

It should be noted that while the user defined parameters configured with respect to table 500 and graph 502 may cause the care-value to hold, increase gradually over time, hold, and decrease gradually over time until closure (if not resolved), other configurations are possible. For example, referring now also to FIG. 6, parameters 302-312 (defined now in table 600) may be may be configured to keep the care-value constant. As shown in table 600 and graph 602, parameters 302-312 may be defined to have no effect at all. Further, referring now also to FIG. 7, user defined parameters 302-312 (defined now in table 700) may be configured to hold the defect (e.g., hold the initial care-value) for longer a period of time, and then decrease the care-value quickly. As shown in table 700 and graph 702, the honeymoon period may last longer, with no attack or sustain periods, and then a short release period may force the defect into closure quickly.

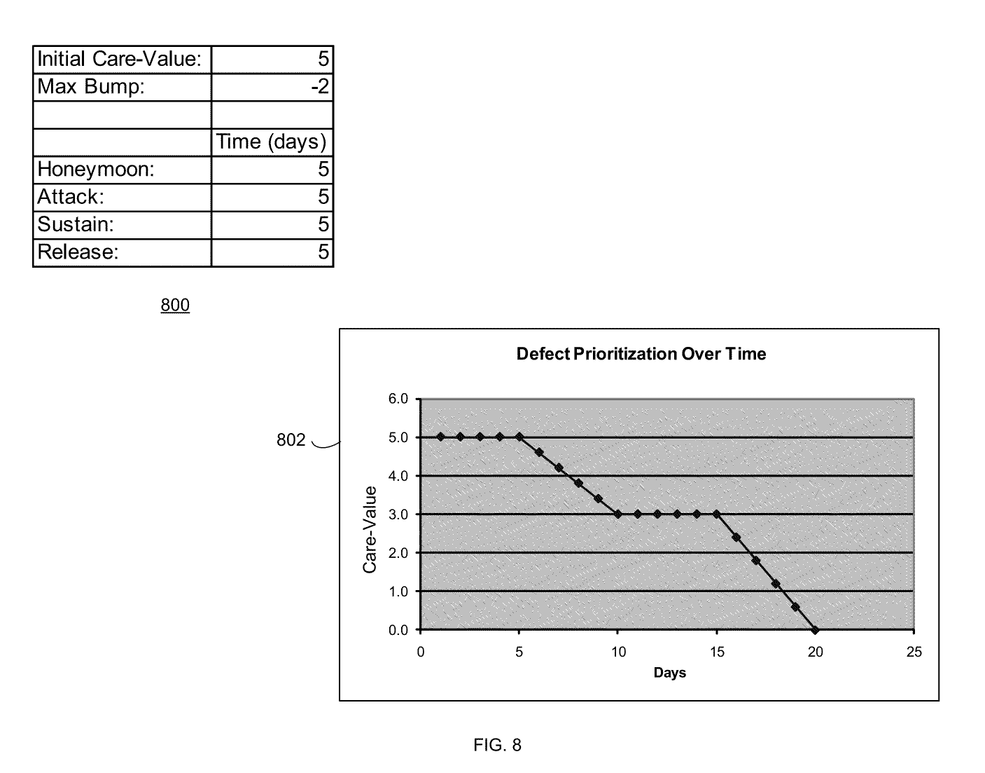

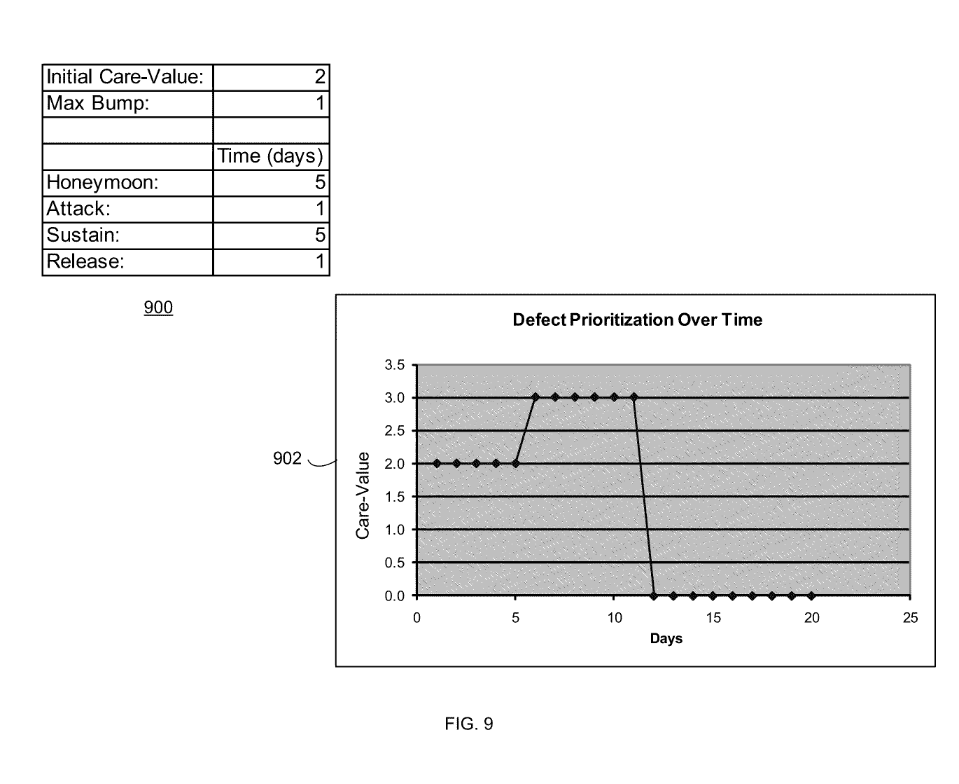

Further, DC process 10 may be configured, via one or more of parameters 302-312, to decrease the priority of the defect over time. For example, and as shown in table 800 and graph 802 of FIG. 8, by entering a negative value for parameter 304 (now defined in table 800 and referred to as “Max Bump”) corresponding to maximum care-value increase, DC process 10 may be configured to decrease the care-value over time and move the defect to closure if unresolved. Additionally, DC process 10 may be configured, via one or more of parameters 302-312, to increase the care-value quickly during the attack period Tₐ and/or decrease the care-value quickly during the release period Tᵣ. For example, and as shown in FIG. 9 by table 900 and graph 902, by entering relatively small values for attack period Tₐ and release period Tᵣ, DC process 10 may be configured to provide a longer sustain period Tₛ.

The term “lean closure” may refer to any defect that may be closed by DC process 10 without being resolved, as described above. Any defect closed through lean closure may be reported for review by the manager. If desired, the manager may reevaluate the defect in light of any comments made on it during its one or more cycles, and may reopen the defect if necessary.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (i.e., a client electronic device), partly on the user's computer, as a stand-alone software package, partly on the user's computer and partly on a remote computer or entirely on the remote computer or server (i.e., a server computer). In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures may illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Further, one or more blocks shown in the block diagrams and/or flowchart illustration may not be performed in some implementations or may not be required in some implementations. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A number of embodiments and implementations have been described. Nevertheless, it will be understood that various modifications may be made. Accordingly, other embodiments and implementations are within the scope of the following claims.

What is claimed is:

1. A method comprising:
allowing, via one or more computing devices, a user to define one or more parameters associated with a defect;
modifying, via the one or more computing devices, a care-value associated with the defect, as a function of time, based upon, at least in part, the one or more parameters defined by the user; and
in response to determining that the defect is unresolved after a configurable time period, closing, via the one or more computing devices, the defect.

2. The method of claim 1, further comprising:
prioritizing the defect based upon, at least in part, the modified care-value.

3. The method of claim 1, further comprising:
notifying one or more team members of the defect based upon, at least in part, the modified care-value.

4. The method of claim 1, wherein the one or more parameters include an initial care-value for the care-value associated with the defect.

5. The method of claim 1, wherein the one or more parameters include a maximum care-value increase for the care-value associated with the defect.

6. The method of claim 1, wherein the one or more parameters include an attack time period for the defect corresponding to an amount of time to increase the care-value associated with the defect to a maximum care-value.

7. The method of claim 1, wherein the one or more parameters include a sustain time period for the defect corresponding to an amount of time to hold the care-value associated with the defect at a maximum care-value.

8. The method of claim 1, wherein the one or more parameters include a release time period for the defect corresponding to an amount of time to decrease the care-value associated with the defect until the defect is closed.

9. The method of claim 1, wherein the one or more parameters include a honeymoon time period for the defect corresponding to an amount of time to hold the care-value associated with the defect at an initial care-value.

10. A computer program product residing on a computer readable storage medium having a plurality of instructions stored thereon, which, when executed by a processor, cause the processor to perform operations comprising:
allowing a user to define one or more parameters associated with a defect;
modifying a care-value associated with the defect, as a function of time, based upon, at least in part, the one or more parameters defined by the user; and
in response to determining that the defect is unresolved after a configurable time period, closing the defect.

11. The computer program product of claim 10, further comprising:
prioritizing the defect based upon, at least in part, the modified care-value.

12. The computer program product of claim 10, further comprising:
notifying one or more team members of the defect based upon, at least in part, the modified care-value.

13. The computer program product of claim 10, wherein the one or more parameters include an initial care-value for the care-value associated with the defect.

14. The computer program product of claim 10, wherein the one or more parameters include a maximum care-value increase for the care-value associated with the defect.

15. The computer program product of claim 10, wherein the one or more parameters include an attack time period for the defect corresponding to an amount of time to increase the care-value associated with the defect to a maximum care-value.

16. The computer program product of claim 10, wherein the one or more parameters include a sustain time period for the defect corresponding to an amount of time to hold the care-value associated with the defect at a maximum care-value.

17. The computer program product of claim 10, wherein the one or more parameters include a release time period for the defect corresponding to an amount of time to decrease the care-value associated with the defect until the defect is closed.

18. The computer program product of claim 10, wherein the one or more parameters include a honeymoon time period for the defect corresponding to an amount of time to hold the care-value associated with the defect at an initial care-value.

19. A computing system comprising:
at least one processor;
at least one memory architecture coupled with the at least one processor;
a first software module executable by the at least one processor and the at least one memory architecture, wherein the first software module is configured to allow a user to define one or more parameters associated with a defect;
a second software module executable by the at least one processor and the at least one memory architecture, wherein the second software module is configured to modify a care-value associated with the defect, as a function of time, based upon, at least in part, the one or more parameters defined by the user; and
a third software module executable by the at least one processor and the at least one memory architecture, wherein the third software module is configured, in response to determining that the defect is unresolved after a configurable time period, close the defect.

20. The computing system of claim 19, further comprising:
a fourth software module executable by the at least one processor and the at least one memory architecture, wherein the fourth software module is configured to prioritize the defect based upon, at least in part, the modified care-value.
